(19) United States
(12) Patent Application Publication
(10) Pub. No.: US 2018/0139275 A1
(43) Pub. Date: May 17, 2018

(54) NEIGHBOR AWARE NETWORK OPERATION FOR NETWORK ONBOARDING AND CONFIGURATION

(71) Applicant: QUALCOMM Incorporated, San Diego, CA (US)

(72) Inventors: Santosh Paul ABRAHAM, San Diego, CA (US); Abhishek Pramod PATIL, San Diego, CA (US); George CHERIAN, San Diego, CA (US)

(21) Appl. No.: 15/711,788

(22) Filed: Sep. 21, 2017

Related U.S. Application Data
(60) Provisional application No. 62/420,880, filed on Nov. 11, 2016.

(51) Int. Cl. H04L 29/08; H04W 16/14; H04W 40/24; H04W 72/04

(52) U.S. Cl. CPC H04L 67/1046; H04W 16/14; H04L 67/1061; H04W 40/246; H04W 72/0453; H04L 67/1087; H04W 40/244

(57) ABSTRACT

Aspects of the present disclosure provide techniques for allowing devices in a first type of network to communicate with devices in a second type of network.

### CLAIM OF PRIORITY UNDER 35 U.S.C. § 119

The present application for patent claims benefit of U.S. Provisional Patent Application Ser. No. 62/420,880, filed Nov. 11, 2016, assigned to the assignee hereof and hereby expressly incorporated by reference herein.

### FIELD OF THE DISCLOSURE

Certain aspects of the present disclosure generally relate to wireless communications and, more particularly, to allowing devices in a first type of network to communicate with devices in a second type of network.

### DESCRIPTION OF RELATED ART

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the desire for greater coverage and increased communication range, various schemes are being developed. One such scheme is the sub-1-GHz frequency range (e.g., operating in the 902-928 MHz range in the United States) being developed by the Institute of Electrical and Electronics Engineers (IEEE) 802.11ah task force. This development is driven by the desire to utilize a frequency range that has greater wireless range than wireless ranges associated with frequency ranges of other IEEE 802.11 technologies and potentially fewer issues associated with path losses due to obstructions.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure provide an apparatus for wireless communications. The apparatus generally includes a processing system configured to generate at least one first frame indicating that the apparatus is capable of providing a first service that allows one or more first type devices to join a network to communicate with one or more second type devices and at least a first interface configured to output the first frame for transmission.

Aspects of the present disclosure provide an apparatus for wireless communications. The apparatus generally includes a first interface configured to obtain a first frame indicating that a first type device is capable of providing a first service that allows the apparatus to join a network to communicate with one or more second type devices, a processing system configured to generate at least a second frame including information to be used by the first type device in authenticating the apparatus as part of a procedure to join the network to communicate with the one or more second type devices, and a second interface configured to output the second frame for transmission.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a diagram of an example wireless communications network, in accordance with certain aspects of the present disclosure.

FIG. 2 illustrates a block diagram of an example access point and user terminals, in accordance with certain aspects of the present disclosure.

FIG. 3 illustrates a block diagram of an example wireless device, in accordance with certain aspects of the present disclosure.

FIG. 4 illustrates an example NAN cluster, in accordance with certain aspects of the present disclosure.

FIG. 5 illustrates an example NAN network with overlapping NAN clusters, in accordance with certain aspects of the present disclosure.

FIG. 6 illustrates an example NAN network with a plurality of NAN Data Link (NDL) clusters, in accordance with certain aspects of the present disclosure.

FIG. 7 is an example time sequence diagram illustrating an example timeline of NAN discovery window periods and NDL time blocks, in accordance with certain aspects of the present disclosure.

FIG. 8 illustrates an exemplary protocol stack, according to aspects of the present disclosure.

FIG. 9 illustrates a block diagram of example operations for wireless communications by an apparatus, in accordance with certain aspects of the present disclosure.

FIG. 9A illustrates example means capable of performing the operations shown in FIG. 9.

FIG. 10 illustrates a block diagram of example operations for wireless communications by an apparatus, in accordance with certain aspects of the present disclosure.

FIG. 10A illustrates example means capable of performing the operations shown in FIG. 10.

FIG. 11 illustrates an example network environment in which aspects of the present disclosure may be practiced.

FIG. 12 illustrates an example network environment in which aspects of the present disclosure may be practiced.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to wireless communications and, more particularly, numerology and frames for neighbor aware networks (NAN) in the sub-1 GHz (S1G) band. As will be described in more detail herein, different types of discovery windows (DWs) of different durations and at different intervals may be defined. A NAN device (e.g., access point (AP) or non-AP station in the NAN) may wake up during one or more types of discovery windows to transmit time synchronization information and/or service discovery information.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA” such as an “AP STA” acting as an AP or a “non-AP STA”) or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communications System

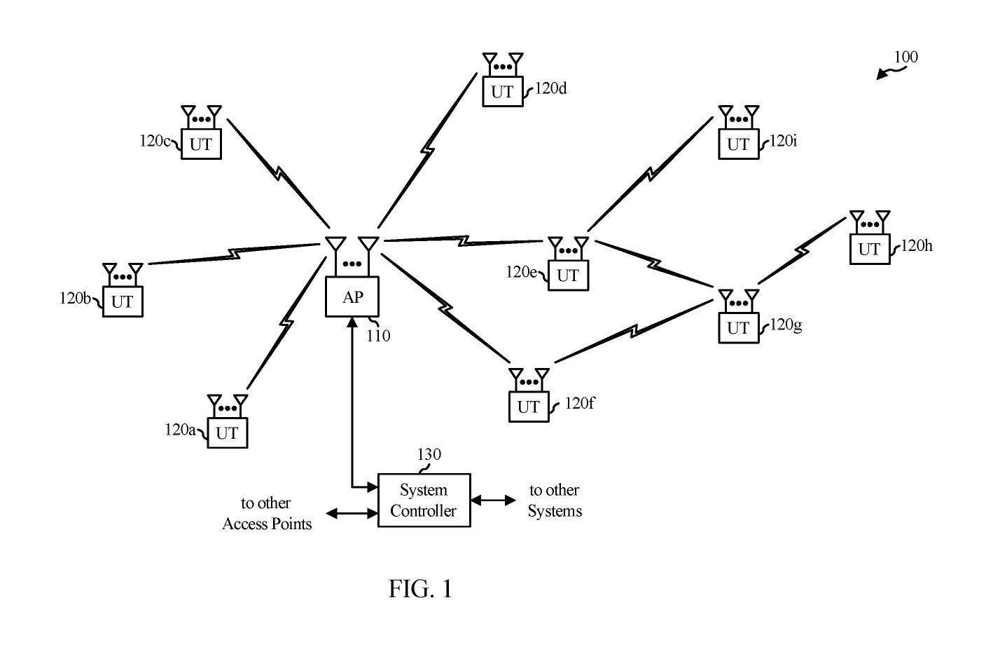

FIG. 1 illustrates a system 100 in which aspects of the disclosure may be performed. For example, any of the wireless stations including the access point 110 and/or the user terminals 120 may be in a neighbor aware network (NAN). A wireless station may wake up during a first type of discovery window having a first duration and occurring at a first interval and send and/or monitor for time synchronization information or service information.

A wireless station may wake up during one or more types of discovery windows to transmit time synchronization information and/or service discovery information. Different types of discovery windows of different durations and at different intervals may be defined.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

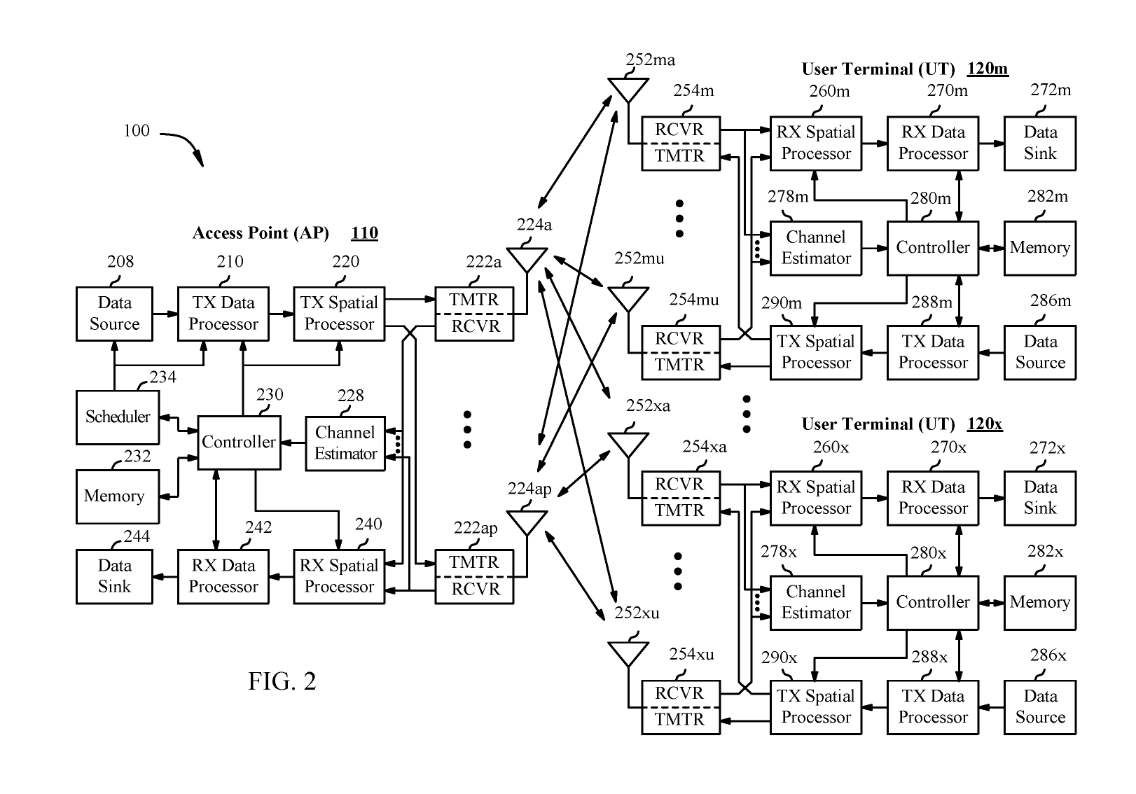

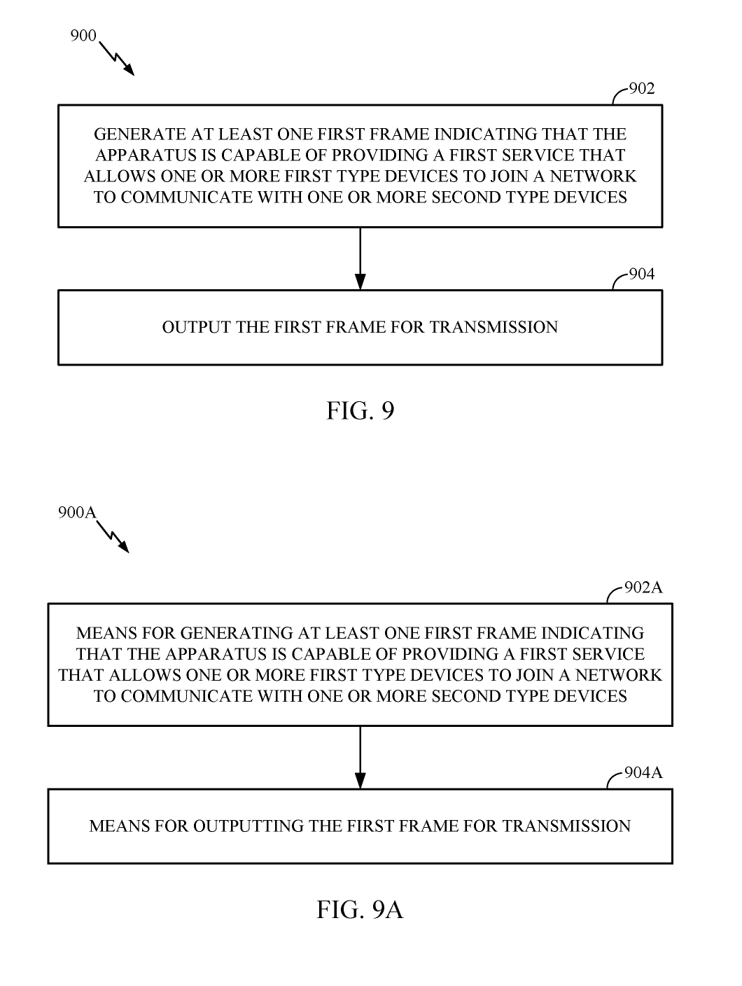

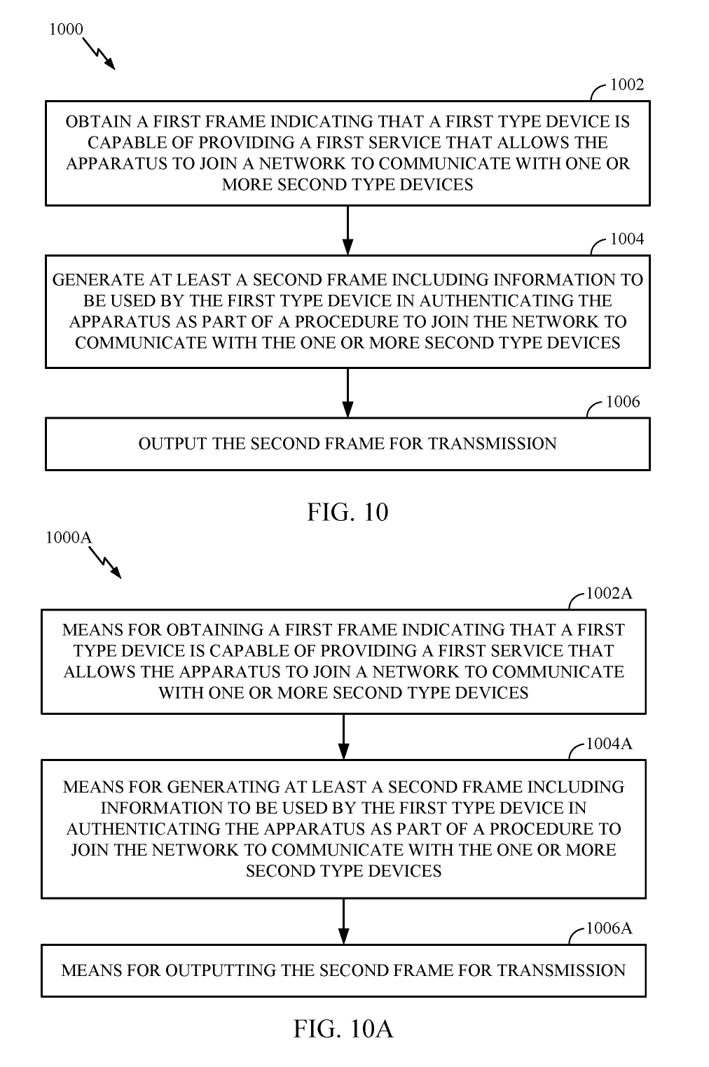

FIG. 2 illustrates example components of the AP 110 and two UTs 120m and 120x, which are examples of the UTs 120 operating in the MIMO system 100 illustrated in FIG. 1. One or more components of the AP 110 and UT 120 may be used to practice aspects of the present disclosure. For example, antenna 224, Tx/Rx 222, processors 210, 220, 240, 242, and/or controller 230 or antenna 252, Tx/Rx 254, processors 260, 270, 288, and 290, and/or controller 280 may be used to perform the operations described herein and illustrated with reference to FIGS. 9 and 10.

The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

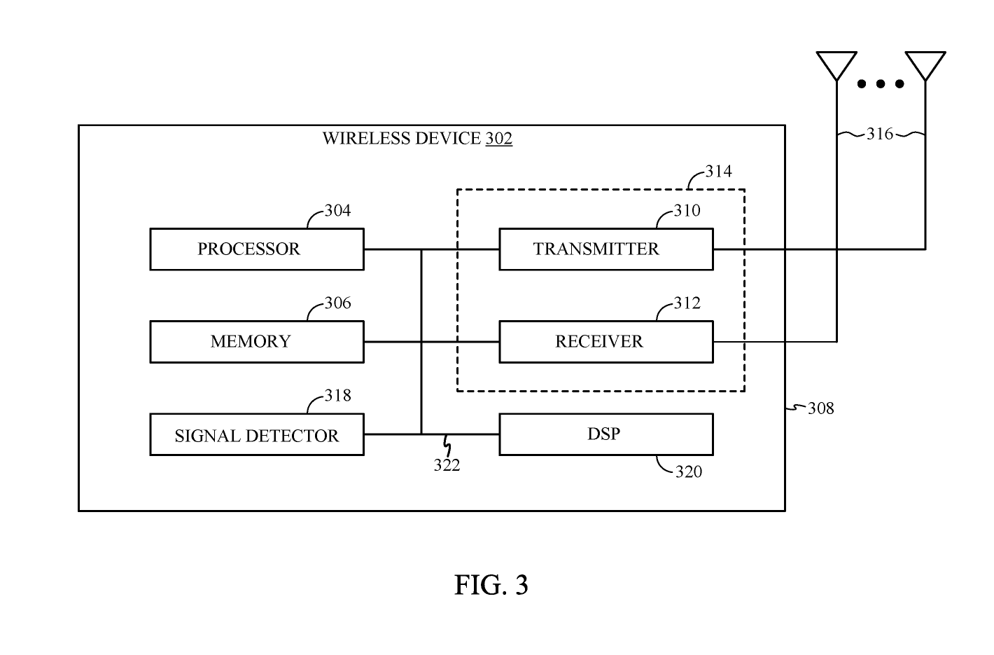

FIG. 3 illustrates various components that may be utilized in a wireless device 302 that may be employed within the MIMO system 100. The wireless device 302 is an example of a device that may be configured to implement the various methods described herein. For example, the wireless device may implement operations 900 and 1000 illustrated in FIGS. 9 and 10. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example Neighbor Aware Network

Due to the increasing popularity of location-enabled (e.g., GPS-enabled) mobile devices, neighbor aware networks (NANs) are emerging. A NAN may refer to a network for communication between stations (STAs) that are located in close proximity to each other. Neighbor aware networking (NAN) provides a mechanism for devices to synchronize the time and channel on which the devices converge to facilitate the discovery of services that have been made discoverable on the existing devices in a NAN or new devices that enter the environment.

A WiFi capable (i.e., capable of communicating according to one or more IEEE 802.11 standards) device that supports NAN protocols and that may be a NAN Master or a NAN non-Master may be referred to as a NAN device.

A NAN discovery window may refer to the time and channel on which NAN devices converge. That is, devices in a NAN may converge on a set of time and frequency resources for exchanging (e.g., transmitting, receiving) information regarding the NAN, referred to as a NAN discovery window. A collection of NAN devices that are synchronized to a same discovery window schedule may be referred to as a NAN cluster.

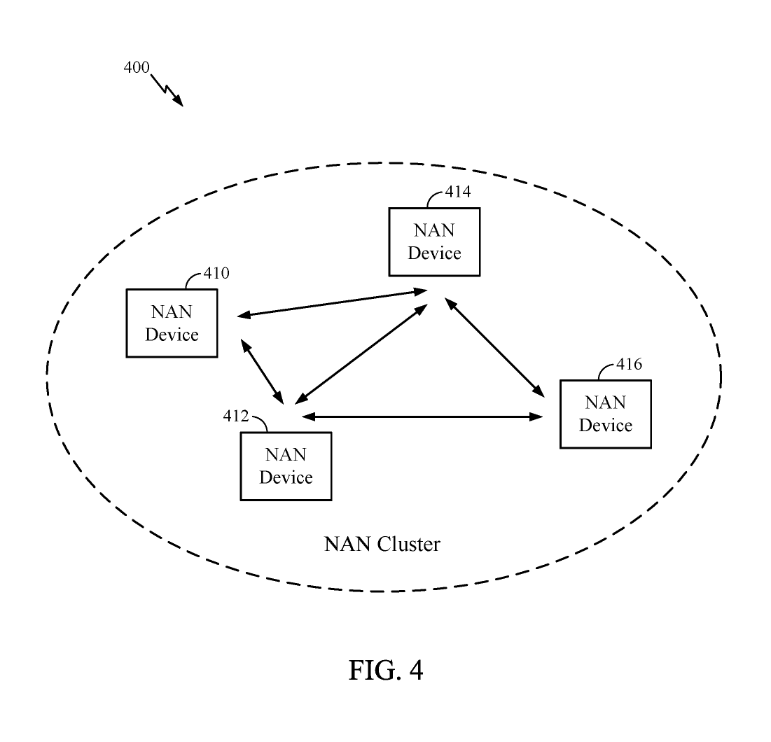

FIG. 4 illustrates an example NAN cluster 400, in accordance with certain aspects of the present disclosure. NAN Devices (e.g., such as AP 110 or user terminal 120) 410, 412, 414, 416 that are part of the same NAN Cluster participate in a NAN Master Selection procedure. Depending on changes in the NAN Cluster, such as NAN Devices becoming part of or leaving the NAN Cluster and Master Ranks of those NAN devices, different NAN Devices may be elected to become NAN Devices in Master role for the NAN cluster at different times.

A NAN ID (identifier or identification) may be used to signify a set of NAN parameters (e.g., discovery channels, discover window times). A NAN network may refer to a collection of NAN clusters that share a same NAN ID.

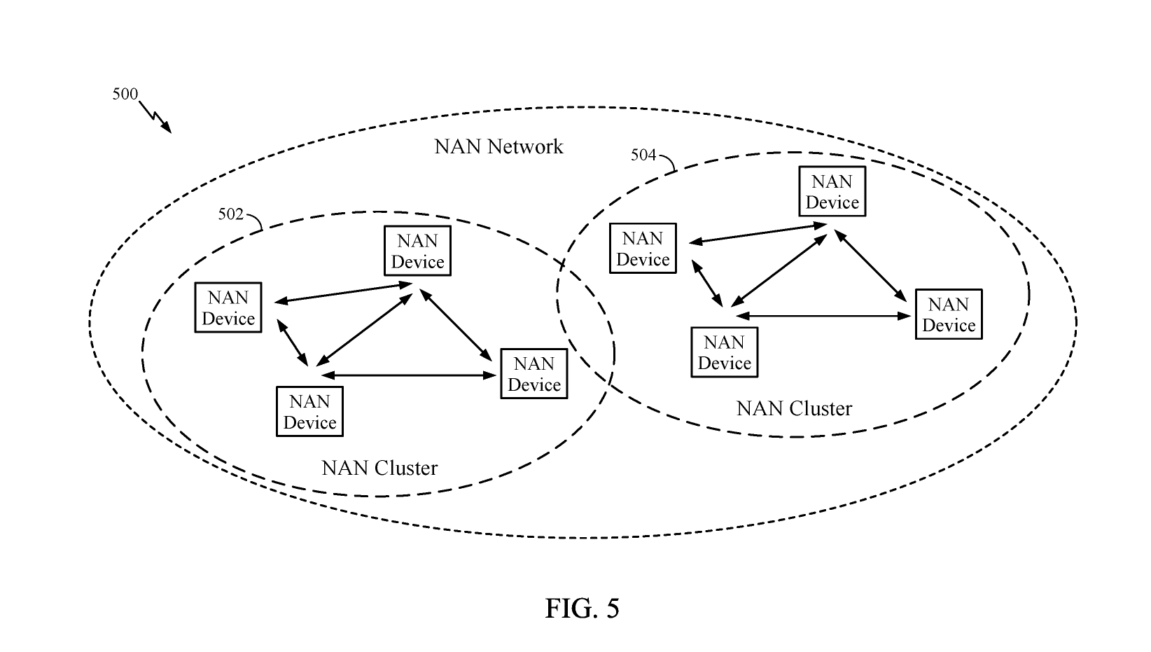

FIG. 5 illustrates an example NAN network 500 with overlapping NAN clusters 502, 504, in accordance with certain aspects of the present disclosure. Although not shown in FIG. 5, a NAN device may participate in more than one overlapping cluster. Also not shown, a NAN device may operate concurrently in a NAN network with other types of WiFi networks (e.g., STAs in different homes or buildings as part of independent LANs with different external network connections), such as a wireless local area network (WLAN) or WiFi Direct. Such devices may provide access to the different networks via a single interface or different interfaces.

NANs generally utilize a discovery window to advertise the existence of devices, services offered by the NAN, and synchronization information. During the discovery window, NAN Devices of the NAN are available (e.g., the NAN devices power on receiver components to listen for transmissions and make themselves available) with high probability for mutual discovery. During interim periods, the devices may be asleep (e.g., in a low power mode with one or more receiver components powered down) or involved with other activities, for example, communicating on other networks and/or a different channel. A NAN device that creates the NAN cluster may define a series of discovery window start times (DWSTs) for discovery windows of the NAN cluster, described below.

NAN Devices participating in the same NAN Cluster are synchronized to a common clock. During a discovery window, one or more NAN Devices transmit NAN Synchronization Beacon frames (also referred to as NAN beacon frames and NAN beacons) to help all NAN Devices within the NAN Cluster synchronize their clocks. A timing synchronization function (TSF) keeps the timers of all NAN Devices in the same NAN Cluster synchronized. The TSF in a NAN Cluster may be implemented via a distributed algorithm, and NAN beacon frames can be transmitted (e.g., by one or more NAN devices in the cluster) according to the algorithm described. A relative starting point or “time zero” may be defined as the first DWST. According to certain aspects, all devices in the NAN may wake up at the first discovery window (DW0), which may be defined, for example, as the discovery window in which the lower 23 bits of a value of the TSF are zero. During subsequent discovery windows, certain NAN devices may choose to be awake (e.g., wake up if in a power save mode) or not be awake (e.g., enter or remain in a power save mode). Synchronization may decrease the discovery latency of devices, power consumption by devices, and medium occupancy by devices that would otherwise occur.

The NAN synchronization procedure is separate from service discovery messaging. Although a NAN Device transmits not more than one Synchronization Beacon in a discovery window, multiple NAN Service Discovery frames may be transmitted by a NAN Device in a discovery window. NAN Service Discovery frames make services discoverable by other NAN Devices, possibly enabling NAN Devices to look for services from other NAN Devices.

Each device within a NAN may have an anchor master rank. The anchor master rank may indicate, for example, the relative accuracy of a clock associated with the device. Devices within a NAN may synchronize clocks with the device in the NAN having a highest anchor master rank (e.g., the device indicated as having the most accurate clock).

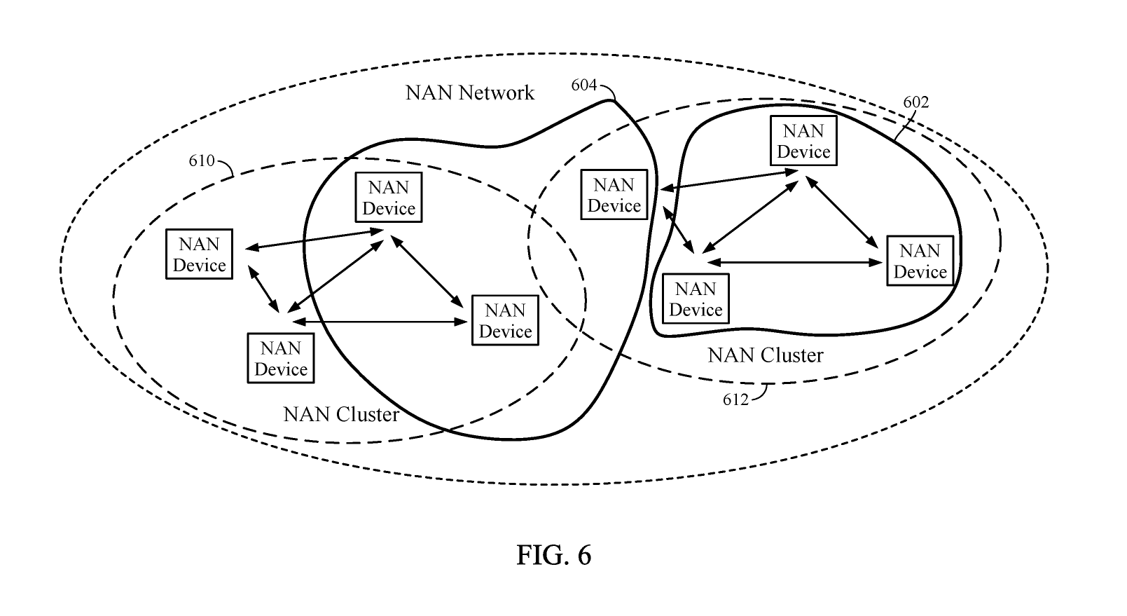

In some cases, as illustrated in FIG. 6, a NAN data link (NDL) cluster 602, 604 may be formed from a plurality of devices that are members of at least one NAN cluster 610, 612. An NDL cluster may comprise members of a single NAN cluster, as illustrated by NDL cluster 602, or members of multiple NAN clusters, as illustrated by NDL cluster 604. A member of an NDL cluster may perform data communications within the NDL cluster, but not necessarily with other members of the NAN to which the member belongs. Devices within an NDL cluster may perform communications within the NDL cluster outside of a NAN discovery window and not concurrently with transmissions within the NAN.

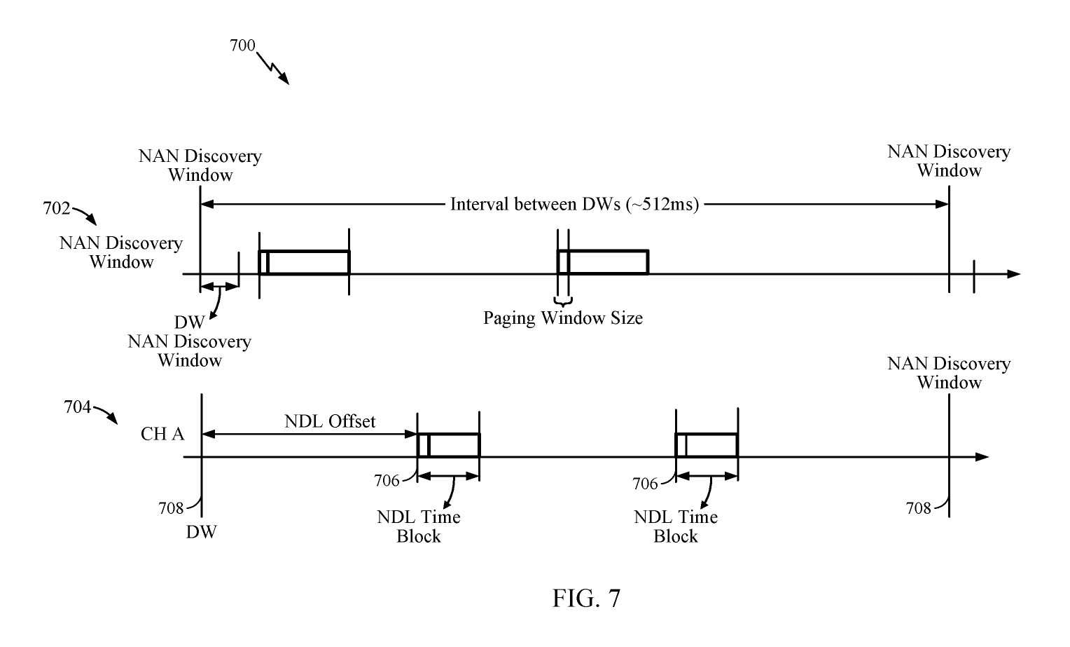

FIG. 7 illustrates an example timeline 700 of communications within a NAN cluster and an NDL cluster. As illustrated, on the NAN discovery channel 702, DWSTs 708 have an interval of 512 time units (TUs) (i.e., the beginning of a discovery window is 512 TUs after the beginning of a previous discovery window). NDL Time Blocks 706, in which communications such as those shown on channel A 704 may be performed within the NDL cluster, may be offset in time from the DWST. In some cases, NDL Time Block times may be set at fixed offsets, relative to the discovery window timeline. That is, each NDL Time Block time may begin a fixed offset from a corresponding DWST. NDL Time Block times may occur according to an NDL base schedule. Devices within an NDL cluster may receive information regarding the NDL base schedule from other devices within the NDL cluster, and may negotiate the NDL base schedule with the other devices.

When a NAN Data Link (NDL) cluster is initialized, an NDL timeline may be determined based on the discovery window timeline of the originating cluster (e.g., the originating NAN cluster). Once the NDL cluster is initialized, the NDL cluster may maintain a timeline that is independent of a discovery window timeline. The NDL timeline may not shift, even as the originating NAN cluster changes. If all devices in the NDL cluster are members of the same NAN cluster, the NDL clock may be synchronized with the NAN clock.

In a dynamic environment, changes in a NAN cluster with which a member of an NDL cluster is associated may in turn cause a shift in a discovery window timeline of the NAN cluster. If, for example, NDL Time Block times are set as a fixed offset from DWSTs as mentioned above, the NDL may fail due to cluster timing changes causing different devices in the NDL cluster to calculate different NDL Time Block times. Since the devices in the NDL cluster may calculate different NDL Time Block times, data transmission in the NDL may be misaligned, causing data communication failures between some devices in the NDL cluster. Thus, techniques for synchronizing timing within an NDL cluster may be desirable.

### Example Thread Network

A Thread network is one example of a secure wireless mesh network that may be used to provide connectivity of devices, such as Internet of Things (IoT) devices, in a home. Thread is implemented using existing technologies, for example, using 6LoWPAN and carrying IPv6 natively. This type of architecture is designed to make it simple and secure to add and remove (IoT) devices to the network. Example devices are appliances, thermostats, and the like.

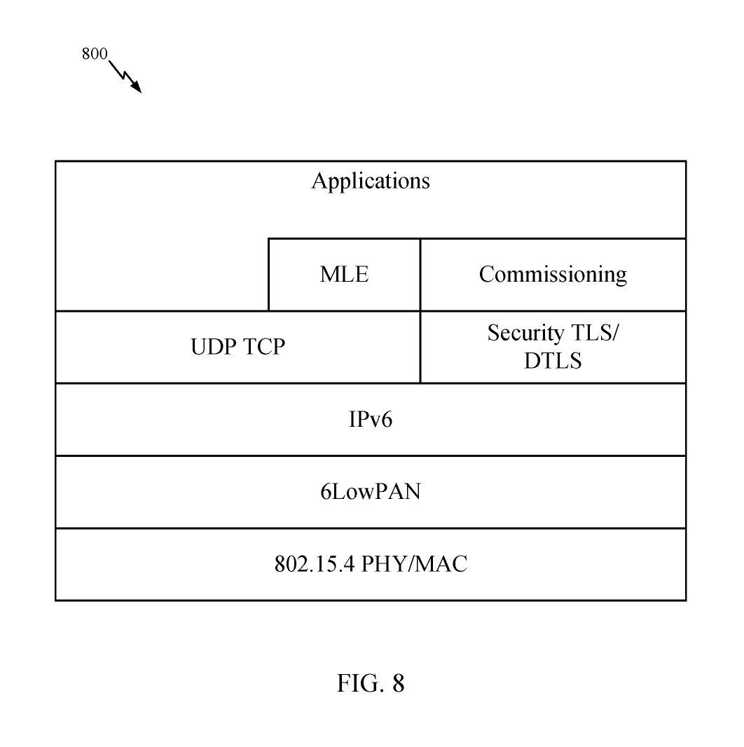

As illustrated in FIG. 8, the Thread protocol defines a protocol stack that is primarily aimed at seamless set up and configuration of networks of IoT devices. As noted above, the Thread protocol provides simple network installation, including simple protocols for forming, joining, and maintaining Thread networks.

Regarding security, devices may not be allowed to join unless authenticated and all communications within a Thread network are typically encrypted. By the use of mesh networking, Thread networks may also enable range extension, by multihop propagation of messages while still providing a degree of reliability, as the failure of a few individual devices does not necessarily collapse the network.

Thread network creation is typically formed by choosing various network parameters. For example, these network parameters may include as a personal area network (PAN) ID, a channel, master key for encryption, and a commissioning credential (PSK), mesh local prefix (e.g., IPv6 ULA prefix), extended PAN ID, and a network name.

A forming node may also serve as a router. To join a thread network, a device may need to obtain some of the network parameters mentioned above (e.g., Master Key, Commissioning Key (PSKs), Mesh-Local Prefix, Extended PAN ID, and network name.

In a thread network, different types of devices may operate in different roles. For example, a full thread device may act as an active router, a router-eligible end device (REED), or a full end device (FED). A minimal thread device may be limited to act as a partial end device (PED) or a sleepy end device (SED). A leader device generally refers to a device that initiates the Thread network, while a parent device generally refers to a router device that can allow devices to join as a child device.

Commissioning generally refers to the procedure by which a device obtains the credentials to join a Thread network in a secure manner. A joining discovers a parent node and communicates through the parent node to the commissioner to obtain the credentials. The commissioner may be provisioned in an out of band (OOB) management fashion with the devices credentials so that it can authenticate the device (and the device can authenticate the commissioner). To become a commissioner, the (to be commissioning device) sends a request petitioning a leader to become a commissioner. An off-network commissioning device, typically a mobile phone, will generally initiate commissioning by discovering the Thread Network through one of its Border Routers. The device then sets up a DTLS connection with the Border Router using the network's Commissioning key (PSKc).

### Example NAN Operation for Network Onboarding and Configuration

Aspects of the present disclosure provide techniques where a certain type of device, referred to herein as a commissioning device, is able to provide a first type of device (e.g., a NAN device) access to a network to communicate with a second type devices (e.g., devices in a mesh network). Of course, the techniques may be expanded to allow communication with other (e.g., third and fourth types) of devices of other types of networks.

In some cases, such techniques may allow NAN devices to communicate with devices in a Thread network (effectively running Thread over NAN).

FIG. 9 illustrates example operations 900 that may be performed by an apparatus (e.g., a station). For example, operations 900 may be performed by a Thread network commissioning device (commissioner) to allow NAN devices to communicate with devices in a Thread network, according to aspects of the present disclosure.

Operations 900 begin at 902, where the apparatus generates at least one first frame indicating that the apparatus is capable of providing a first service that allows one or more first type devices to join a network to communicate with one or more second type devices. At 904, the apparatus outputs the frame for transmission.

FIG. 10 illustrates example operations 1000 that may be performed by an apparatus (e.g., a station). For example, operations 1000 may be performed by a NAN device seeking to join a Thread network via a Thread commissioner performing operations 900 described above.

Operations 1000 begin at 1002, where the apparatus obtains a first frame indicating that a first type device is capable of providing a first service that allows the apparatus to join a network to communicate with one or more second type devices. At 1004, the apparatus generate at least a second frame including information to be used by the first type device in authenticating the apparatus as part of a procedure to join the network to communicate with the one or more second type devices. At 1006, the apparatus outputs the second frame for transmission.

The operations described above may enable NAN capable devices to join/set up a Thread network. The operations may allow seamless connection to devices are on the Thread network, irrespective of RAT. According to certain aspects, the capability to provide such connection (as a commissioner) may be advertised as a “Service” over NAN (e.g., by a NAN device that has petitioned to serve as a commissioner).

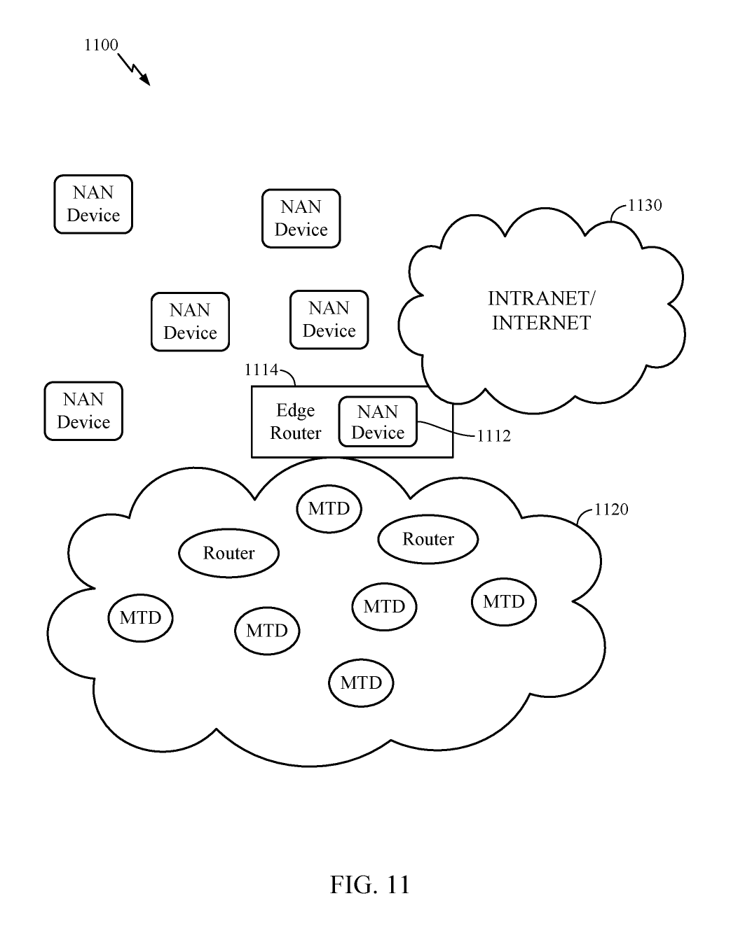

As illustrated in the example scenario 1100 depicted in FIG. 11, in some cases, a NAN device 1112 may initiate Thread network with commissioner access through Edge Router 1114. As illustrated, the Edge Router 1114 may provide devices (e.g., IoT devices) of a network 1120 with access, for example, to a wide area local network 1130.

The example shown in FIG. 11 may assume such a commissioning device (as NAN device 1112) is available for access and may publish (via a frame that indicates) the following services for Thread network access:

Service Name 1: org.wifi.Thread.Commision

Service Name 2: org.wifi.Thread.unicast
SRF 1: Network Name
Service Specific Info Carries:
   Other Thread Network Information
   Thread device functionality, type etc

Service Name 3: org.wifi.Thread.Multicast
SRF 1: Network Name
Service Specific Info Carries:
Type: Many to Many

In some cases, the Edge Router may also initiate an NDC time line and a Network Management System group (NMSG) with Multicast Schedule for Service 2 and 3. To simplify timing, the NDC time line and Multicast Schedule may be the same.

After the commissioning device publishing services, thread enabled NAN devices may decide to join the Thread network via the Edge Router as follows. The joining device may:
1. Subscribe to the commission service and establish non-secure data link to Edge Router;
2. Obtain credentials including “Master Key” for joining Thread Network and other Network Properties (and use TLS to secure this communication over the non-secure data link);
3. Subscribe to unicast and multicast Thread service with Network Name as obtained from the Commissioner;
4. Initiate NDP to the Edge Router and join NMSG for the thread service advertised by the Edge Router using the Master Key obtained from the commissioning procedure;
   In this manner, a joining device can communicate securely using a non-secure data link, for example, by encoding data with the credentials obtained as part of the joining process. In other words, after joining, the device may generate frames (packets) containing data encoded accordingly (or separately encode data to be included in such frames).

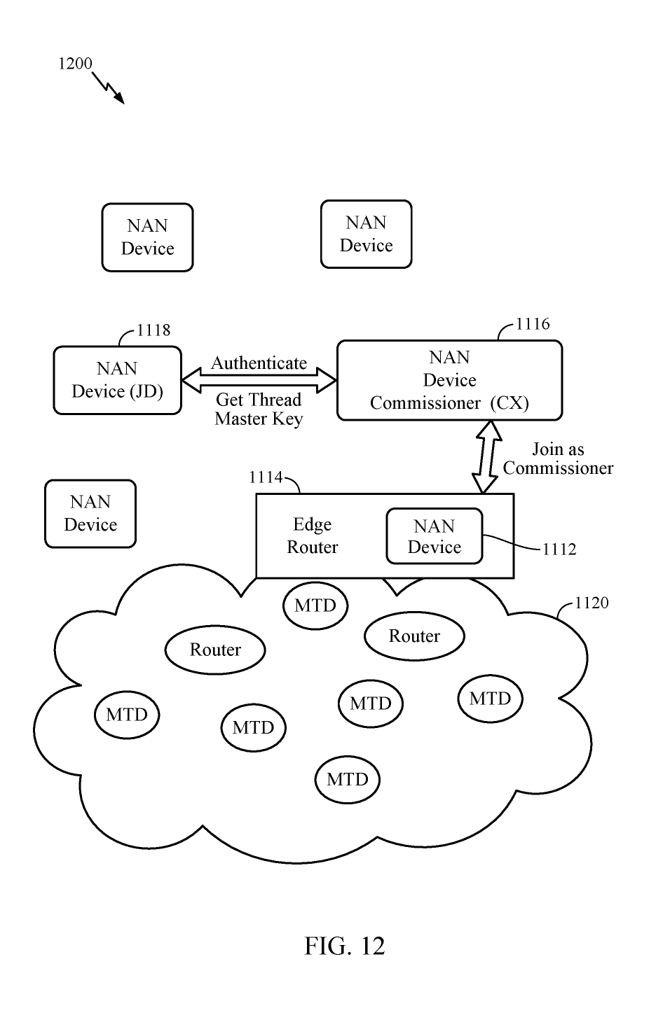

In some cases, as illustrated in FIG. 12, a NAN device CX 1116 (separate from an Edge router 1114) may serve as Commissioner. In this case, the Edge Router may advertise the capability to configure devices as a commissioner (e.g., via an org.wifi.Thread.ConfigureCommisioner service). The CX NAN Device (or simply CX) 1116 may then obtain Network Commissioner information from Edge Router.

Subsequently, the CX may advertise its own commissioning service (org.wifi.Thread.Commision) and may obtain joining device (JD) credentials from a JD (1118) by the OOB method described above. As illustrated in FIG. 12, the JD subscribes to commission service at CX and obtains the Master Key and Network Name for the Thread Network. The JD may then use the Master Key obtained to set up links to other (joined) devices in the thread network.

The Master Key may also be used for secure communications between NAN devices (e.g., using a set derived from the Master Key). In other words, NAN devices that join (the Thread network) may be able communicate with each other securely using the keys based on the Master Key of the thread network.

In this manner, NAN devices may be interconnected using Thread Credentials. For example, all devices in the NAN Thread Service may publish the two Thread services:

Service Name 2: org.wifi.Thread.unicast

Service Name 3: org.wifi.Thread.Multicast (Many to Many)

Devices may use a master service key (MSK) derived from the Thread Master Key to set up the NDPs between the Thread devices and also join the many to many NMSG.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 900 illustrated in FIG. 9 correspond to means 900A illustrated in FIG. 9A and operations 1000 illustrated in FIG. 10 correspond to means 1000A illustrated in FIG. 10A.

For example, means for receiving, means for obtaining, and means for communicating may be a receiver (e.g., the receiver unit of transceiver 254) and/or an antenna(s) 252 of the user terminal 120 illustrated in FIG. 2, the receiver (e.g., the receiver unit of transceiver 222) and/or antenna(s) 224 of access point 110 illustrated in FIG. 2, or the receiver 312, antennas 316, and/or the bus system 322 illustrated in FIG. 3. Means for transmitting and means for outputting may be a transmitter (e.g., the transmitter unit of transceiver 254) and/or an antenna(s) 252 of the user terminal 120 illustrated in FIG. 2, the transmitter (e.g., the transmitter unit of transceiver 222) and/or antenna(s) 224 of access point 110 illustrated in FIG. 2, or the transmitter 310, antennas 316, and/or the bus system 322 illustrated in FIG. 3.

Means for generating, means for establishing, means for providing, means for obtaining, means for using, means for deciding, means for encoding, and means for joining may comprise a processing system, which may include one or more processors, such as the RX data processor 270, the TX data processor 288, and/or the controller 280 of the user terminal 120 illustrated in FIG. 2 or the TX data processor 210, RX data processor 242, and/or the controller 230 of the access point 110 illustrated in FIG. 2.

According to certain aspects, such means may be implemented by processing systems configured to perform the corresponding functions by implementing various algorithms (e.g., in hardware or by executing software instructions) described above. For example, an algorithm for determining a data communication window (DCW) timeline for communicating data between a group of devices including the apparatus, and algorithm for maintaining a local clock for the DCW timeline, and an algorithm for updating the local clock based on at least one of a relative drift between the local clock and the clock associated with the first network cluster, or a move of the apparatus from the first network cluster to a second network cluster, may be implemented by processing systems configured to perform the above functions.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for determining occurrence of a first type of discovery window for a network that occurs according to a first interval, instructions for determining occurrence of a second type of discovery window for the that occurs according to a second interval shorter than the first interval, instructions for obtaining, from at least one other apparatus associated with the network, at least one of time synchronization information or service information during at least one of the first type of discovery window or the second type of discovery window, and instructions for outputting, for transmission in the network, at least one of the time synchronization information or the service information during at least one of the first type of discovery window or the second type of discovery window.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to:
generate at least one first frame indicating that the apparatus is capable of providing a first service that allows one or more first type devices to join a network to communicate with one or more second type devices; and
at least a first interface configured to output the first frame for transmission.

2. The apparatus of claim 1, wherein the first frame further indicates at least one of an identification of the network, a protocol identifier, or a functionality of the one or more second type devices.

3. The apparatus of claim 1, wherein:
the processing system is further configured to establish a non-secure data communication link with at least one of the first type devices and generate one or more second frames with portions encoded using authenticated information obtained from the at least one of the first type devices; and
the first interface is configured to output the one or more second frames for transmission via the non-secure data communication link.

4. The apparatus of claim 1, wherein:
the processing system is further configured to generate at least one second frame providing one or more credentials to at least one of the first type devices via a non-secure data communication link, as part of the first service; and
the first interface is further configured to output the second frame for transmission.

5. The apparatus of claim 4, wherein the one or more credentials comprise a master key for joining the network via a second service provided by the apparatus.

6. The apparatus of claim 5, wherein:
the processing system is further configured to generate at least one third frame indicating that the apparatus is capable of providing the second service; and
the first interface is further configured to output the third frame for transmission.

7. The apparatus of claim 1, wherein the apparatus further comprises:
at least a second interface configured to provide devices that have joined the network access to an external network.

8. The apparatus of claim 1, wherein:
the processing system is configured to generate at least a second frame to request to join the network and provide the first service; and
the first interface is further configured to output the second frame for transmission.

9. The apparatus of claim 8, further comprising:
at least a second interface configured to obtain, after generating the at least one second frame, a third frame containing configuration information for providing the first service; and
wherein the processing system is configured to use the configuration information when providing the first service.

10. An apparatus for wireless communications, comprising:
a first interface configured to obtain a first frame indicating that a first type device is capable of providing a first service that allows the apparatus to join a network to communicate with one or more second type devices;
a processing system configured to generate at least a second frame including information to be used by the first type device in authenticating the apparatus as part of a procedure to join the network to communicate with the one or more second type devices; and
a second interface configured to output the second frame for transmission.

11. The apparatus of claim 10, wherein the processing system is configured to decide whether to join the network based on at least one of an identification of the network, a protocol identifier, or a functionality of the one or more second type devices included in the first frame.

12. The apparatus of claim 10, wherein:
the processing system is further configured to encode data using the information included in the second frame and generate a third frame including the encoded data; and
the second interface is configured to output the third frame for transmission via a non-secure data communication link.

13. The apparatus of claim 12, wherein:
the first interface is further configured to obtain at least a third frame, via the non-secure data communication link, from the first device, the at least one third frame including one or more credentials; and
the processing system is configured to join the network by using the one or more credentials.

14. The apparatus of claim 13, wherein the one or more credentials comprise a master key for joining the network via a second service provided by the first device.

15. The apparatus of claim 14, wherein the processing system is configured to use the master key for secure communications with one or more first type devices.

16. The apparatus of claim 14, wherein:
the first interface is further configured to obtain at least one fourth frame indicating that the first device is capable of providing the second service; and
the processing system is configured to join the network after obtaining the fourth frame.

17-48. (canceled)

49. A wireless station, comprising:
a processing system configured to:
generate at least one first frame indicating that the wireless station is capable of providing a first service that allows one or more first type devices to join a network to communicate with one or more second type devices; and
a transmitter configured to transmit the first frame.

53. The apparatus of claim 10, further comprising at least one antenna via which the first frame is received and the second frame is transmitted.
